(19) United States
(12) Patent Application Publication
(10) Pub. No.: US 2025/0118280 A1
(43) Pub. Date: Apr. 10, 2025

(54) ACOUSTIC MUSICAL INSTRUMENT WITH DIGITAL STRINGS

(71) Applicants: Dmitry ELYASHEV, Bat Yam (IL); Vitaly Valentinovich NAZAROV, Moscow (RU); Leonid ASTRIN, Tel Aviv (IL)

(72) Inventors: Dmitry ELYASHEV, Bat Yam (IL); Vitaly Valentinovich NAZAROV, Moscow (RU); Leonid ASTRIN, Tel Aviv (IL)

(21) Appl. No.: 18/907,878

(22) Filed: Oct. 7, 2024

Related U.S. Application Data
(60) Provisional application No. 63/542,820, filed on Oct. 6, 2023.

(51) Int. Cl. G10H 1/34

(52) U.S. Cl. CPC G10H 1/342; G10H 2230/145

(57) ABSTRACT

An acoustic musical instrument is provided, in which a sounding board is excited by at least three actuators instead of strings to produce a musical sound of interest. The actuators are attached to the sounding board at least three user-defined attachment points and configured to cause the sounding board to perform oscillations that reproduce the musical sound of interest. The actuators are controlled by using control signals which are generated based on input information about the musical sound of interest. More specifically, the control signal for each actuator causes the actuator to exert an excitation force on the sounding board that corresponds to a required oscillation amplitude and phase at the user-defined attachment point of the actuator.

### TECHNICAL FIELD

The present disclosure relates to the field of acoustic musical instruments. In particular, the present disclosure relates to a stringless acoustic musical instrument in which a set of actuators is used instead of strings to cause a sounding board to produce a musical sound of interest.

### BACKGROUND OF THE INVENTION

Acoustic musical instruments, such as upright pianos and grand pianos, are known to contain a string excitation mechanism, strings fixed to a rigid support, a soundboard (also referred to as a sounding board) also fixed to the rigid support, and a bridge connecting the strings to the soundboard. However, the known acoustic musical instruments suffer from many drawbacks. For example, in addition to their high price, enormous weight and large size, conventional pianos require frequent tuning and periodic expensive maintenance. Moreover, their sound depends on climatic conditions, room geometry, wear of their parts and other factors.

RU 2364956 C1 (published on Aug. 20, 2009) discloses a musical synthesizer comprising a Musical Instrument Digital Interface (MIDI) sequence input unit, a MIDI analysis unit, string parameter generation units, and a hammer parameter generation unit. These units are operatively connected through a sound generation unit to a filter and a sound reproducing device. The string and hammer parameter generation units and the sound generation unit are configured to physically model the behavior of a set of strings attached to a common soundboard, all at the same single point, wherein each string is excited by a hammer strike. This modeling considers different factors, such as a bending rigidity, string tension force, damper position, as well as the mass, shape, weight, and material of the hammer, and the coordinates of the hammer strike on the string. The known musical synthesizer provides an improved approximation of the synthesized sound to that of a real musical instrument, thereby resulting in a more realistic experience similar to playing a conventional, non-electronic piano. However, the significant limitation of this and other similar musical synthesizers is that the sound reproducing device or, in other words, sound emitter is represented by an acoustic system based on various types of loudspeakers. The sound field generated by such acoustic systems is not identical to the one produced by the soundboard of a real musical instrument. Since human perception of the sound field involves not only auditory perception but also somatosensory perception, such discrepancies are always perceptible. On top of that, the dynamic range of such acoustic systems is significantly narrower than that of a piano, resulting in the need for sound compression which can substantially distort the sound.

### SUMMARY OF THE INVENTION

This summary is provided to introduce a selection of concepts in a simplified form that are further described below in the detailed description. This summary is not intended to identify key features of the present disclosure, nor is it intended to be used to limit the scope of the present disclosure.

It is an objective of the present disclosure to provide an acoustic musical instrument (e.g., piano-like) in which a sounding board is excited by actuators instead of strings to produce a musical sound of interest.

The objective above is achieved by the features of the independent claim in the

appended claims. Further embodiments and examples are apparent from the dependent claims, the detailed description, and the accompanying drawings.

According to an aspect, an acoustic musical instrument is provided, which comprises a rigid body, a sounding board, three or more actuators, an input unit, and a processing unit. The sounding board is made of a flexible material and attached to the rigid body. Each actuator is attached to the sounding board at a user-defined attachment point. The actuators are configured to cause the sounding board to perform oscillations that reproduce a musical sound of interest. The input unit is configured to receive input information about the musical sound of interest. The processing unit is configured to receive the input information from the input unit and use it to calculate an amplitude and phase of the oscillations to be performed by the sounding board at each user-defined attachment point. The processing unit is further configured to generate, for each of the actuators, a control signal causing the actuator to exert an excitation force on the sounding board that corresponds to the calculated amplitude and phase of the oscillations at the corresponding user-defined attachment point. The processing unit is further configured to provide the control signals to the actuators. The acoustic musical instrument thus configured may produce a high-quality sound in a wider dynamic range compared to conventional stringed musical instruments. Moreover, the absence of strings and mechanical parts in the acoustic musical instrument means that it does not require frequent tuning and periodic expensive maintenance (e.g., unlike conventional pianos).

In an exemplary embodiment, the sounding board is implemented as a soundboard of a stringed musical instrument, and the actuators are attached to the sounding board at the user-defined points, the exact locations of the attachment points are calculated using 3d modelling of the soundboard with the Finite Elements method. Thus, the acoustic musical instrument according to the present disclosure may generate and provide the control signals to the actuators fixed on the sounding board in such a way that the resulting movement of the sounding board is similar to or even identical to the movement caused by the real strings attached to the soundboard of the stringed musical instrument.

In an exemplary embodiment, the input unit is implemented as a keyboard of the stringed musical instrument, and the input information comprises a note identifier (e.g., number/name) and a note velocity. By using the keyboard, it is possible to play multiple notes at once, thereby creating a variety of musical compositions. The input information associated with the notes may be used to more correctly generate the control signals for the actuators, thereby contributing to the production of a more realistic sound by the sounding board.

In an exemplary embodiment, the input is a MIDI keyboard, and the input information is configured as a MIDI sequence. The MIDI keyboard may allow one to record and produce music in different genres without the need for multiple physical musical instruments. With the MIDI input, the acoustic musical instrument according to the present disclosure may be used to compose a wider variety of music digitally.

In an exemplary embodiment, the processing unit is configured to calculate the amplitude and phase of the oscillations to be performed by the sounding board at each of the user-defined attachment points by analyzing interaction between the strings and the soundboard of the (real) stringed musical instrument using an explicit finite difference scheme. The use of the explicit finite difference scheme allows to generate the control signals for the actuators more correctly, so that the sound produced by the sounding board is closer to the one produced by a stringed musical instrument (e.g., piano).

In an exemplary embodiment, each of the actuators is implemented as an electromagnetic or piezoelectric actuator. These types of actuators may be used to excite the sounding board more efficiently and correctly over a wide dynamic range of sound.

Other features and advantages of the present disclosure will be apparent upon reading the following detailed description and reviewing the accompanying drawings.

### BRIEF DESCRIPTION OF DRAWINGS

The present disclosure is explained below with reference to the accompanying drawings in which:

FIG. 1 schematically shows a physical model of a conventional musical instrument

containing strings and a sounding board;

FIG. 2 schematically shows positions of the strings of the conventional musical instrument at previous, current and subsequent moments in time;

FIGS. 3A-3F schematically show first six modes of natural oscillations of a sounding board of a conventional piano;

FIG. 4 schematically illustrates how oscillation amplitudes along points of attachment of the strings to the sounding board of the conventional musical instrument can be expressed via modal coefficients;

FIG. 5 shows a schematic block diagram of an acoustic musical instrument according one exemplary embodiment;

FIG. 6 shows a schematic block diagram of a processing unit that may be used in the acoustic musical instrument of FIG. 5;

FIG. 7 shows some structural details and functions of the processing unit of FIG. 6; and

FIG. 8 shows a schematic diagram of an electromagnetic actuator that may be used in the acoustic musical instrument of FIG. 5.

### DETAILED DESCRIPTION OF THE INVENTION

Various embodiments of the present disclosure are further described in more detail with reference to the accompanying drawings. However, the present disclosure can be embodied in many other forms and should not be construed as limited to any certain structure or function discussed in the following description. In contrast, these embodiments are provided to make the description of the present disclosure detailed and complete.

According to the detailed description, it will be apparent to the ones skilled in the art that the scope of the present disclosure encompasses any embodiment thereof, which is disclosed herein, irrespective of whether this embodiment is implemented independently or in concert with any other embodiment of the present disclosure. For example, the apparatus disclosed herein can be implemented in practice by using any numbers of the embodiments provided herein. Furthermore, it should be understood that any embodiment of the present disclosure can be implemented using one or more of the elements presented in the appended claims.

As used in the exemplary embodiments disclosed herein, a musical sound may refer to any tone with characteristics such as controlled pitch and timbre. As is well-known, musical sounds may be produced by acoustic oscillations of a sounding board included in an acoustic musical instrument, such as a piano.

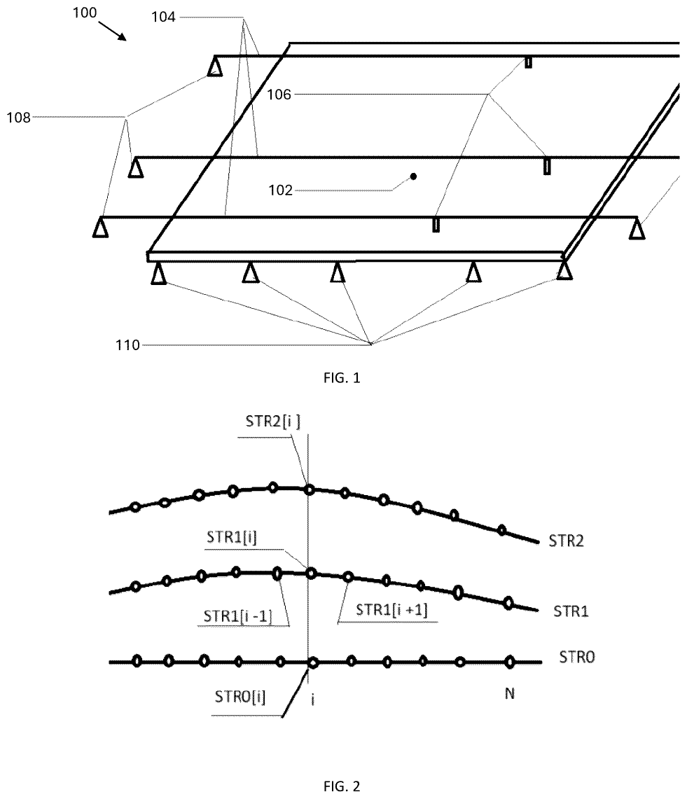

FIG. 1 schematically shows a physical model of a conventional musical instrument 100 comprising a sounding board 102 and strings 104. The sounding board 102 is usually made of wood (e.g., maple, beech, birch, spruce). The strings 104 are usually made of metal (e.g., steel) or synthetics (e.g., nylon, kevlar) and attached to the sounding board 102 at points 106 and to a rigid support (not shown) of the instrument 100 at points 108. It should be noted that the rigid support may be implemented as a frame if the instrument 100 is a piano, for example. For physical modelling, there are also boundary points or conditions 110 shown in FIG. 1 for the sounding board 102.

FIG. 2 schematically shows positions of each of the strings 104 of the instrument 100 at previous, current and subsequent moments in time. More specifically, in FIG. 2, the strings 104 are designated as STR0, STR1, and STR2, and their positions at the previous, current, and subsequent moments in time correspond to points i−1, i, and i+1, respectively.

It is well-known that when a solid body (like the sounding board 102 in the instrument 100) is subjected to a disturbance, it vibrates in specific patterns, known as vibration modes or normal modes. Each mode corresponds to a specific frequency, known as a natural frequency or resonant frequency. In the linear approximation, any motion of such a rigid body can be represented as a sum of its mode oscillations.

The vibration modes of the sounding board 102 are determined by its material properties (such as density, elasticity, and internal damping), geometry, and the boundary conditions 110 (how the body is supported or constrained). The frequencies, profiles and q-factors of the modes can be found using the standard methods of modal analysis.

For each mode, every point on the sounding board 102 undergoes sinusoidal oscillations with the same phase, but with varying amplitudes corresponding to the mode's amplitude at that specific point, accounting for the sign. The profiles of these amplitudes along the points 106 where the strings 104 are attached to the sounding board 102 are referred to as modal coefficients for the instrument 100.

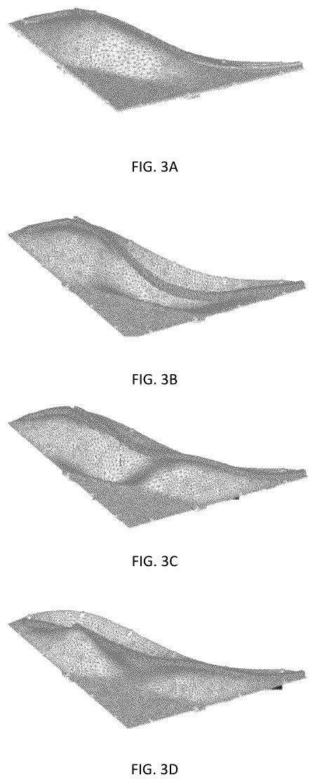

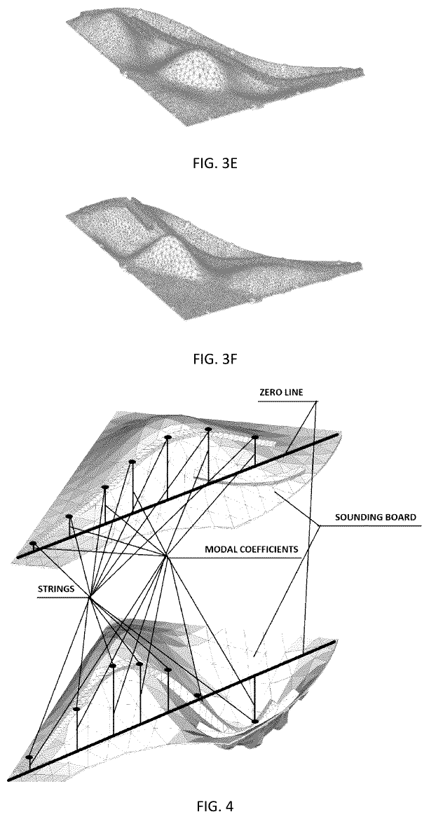

FIGS. 3A-3F schematically show first six modes of natural oscillations of a sounding board of a conventional piano. These six modes were calculated using the finite element method. For the first two modes (see FIGS. 3A and 3B), how the amplitudes of their oscillations along the attachment points of the string to the sounding board can be expressed through the modal coefficients is shown in FIG. 4, where the zero line corresponds to the resting position of the sounding board.

The exemplary embodiments disclosed herein relate to an acoustic musical instrument in which a sounding board is excited by at least three actuators instead of strings to produce a musical sound of interest. Each actuator is attached to the sounding board at a user-defined attachment point, and they are configured, in concert, to cause the sounding board to perform oscillations that reproduce the musical sound of interest. The actuators are controlled by using control signals which are generated based on input information about the musical sound of interest. More specifically, the control signal for each actuator causes the actuator to exert an excitation force on the sounding board that corresponds to a required oscillation amplitude and phase at the user-defined attachment point of the actuator.

In general, the stringless instrument according to the present disclosure is based on the hardware implementation of the above-mentioned physical model of a stringed musical instrument, in which the strings transfer their energy to the sounding board through their attachment points. The main difference of the stringless instrument according to the present disclosure is that the role of the strings is played by the actuators which are properly controlled based on the musical sound of interest. The resulting movement of the sounding board is similar or even identical to the movement that would be caused by the real strings.

FIG. 5 shows a schematic block diagram of an acoustic musical instrument 500 according one exemplary embodiment. The instrument 500 may be implemented as a stringless piano-like instrument. The instrument 500 comprises a rigid body 502, a sounding board 504, a set of actuators 506, an input unit 508, and a processing unit 510.

The sounding board 504 is made of a flexible or pliable material configured to vibrate in response to an external disturbance (e.g., wood) and attached to the rigid body 502. The set of actuators 506 is attached to the sounding board 502 at user-defined attachment points which may coincide with attachment points of strings to the soundboard of a real stringed instrument (e.g., with the points of attachment of strings to the soundboard of a piano, guitar, violin, harp, etc.). At the same time, the user-defined attachment points for the actuators 506 may be different from those where the strings are attached to the soundboard of the real stringed instrument-for example, the geometry and the vibrational behavior of the material of the sounding board 502 (e.g., its modes of oscillation) may be studied and analyzed first and then be used to properly distribute the actuators 506 across the sounding board 502. Said study and analysis may be done with the help of 3D modeling of the sounding board 502 with the well-known finite element method. The actuators 506 themselves may be implemented as piezoelectric and/or electromagnetic actuators which are well-known in the art. After installation the actuators has to be calibrated and tuned, as the quality of sound depends from the precision with which the actuators are tuned to the frequency and phase parameters of the soundboard modes. The actuators 506 should be able to cause the sounding board 502 to perform oscillations that reproduce a musical sound of interest.

The input unit 508 is configured to receive input information about the musical sound of interest. In one embodiment, the input unit 508 may be implemented as a keyboard of a real stringed musical instrument, like a piano keyboard, and the input information may comprise note-related data, such as a note identifier (e.g., note number or name) and a note velocity (i.e., a parameter that indicates how hard a certain key was struck when the note was played, which may usually correspond to the note's loudness). In a preferred embodiment, the keyboard is a MIDI keyboard configured to generate the input information as a MIDI sequence signal. At the same time, the present disclosure is not limited to this specific type of the input unit 508—in some other embodiments, the input unit 508 may be implemented as any user input device configured to receive similar note-related information and transmit it to the instrument 500 (i.e., the processing unit 510) in a wired or wireless manner (e.g., such a user input device may download this information from a remote server or an individual MIDI keyboard).

The processing unit 510 is configured to receive the input information from the input unit 508 and use it to calculate an amplitude and phase of the oscillations to performed by the sounding board 502 at each of the user-defined attachment points. The processing unit 510 is further configured to generate, for each actuator 506, a control signal causing the actuator 506 to exert an excitation force on the sounding board 502 that corresponds to the calculated amplitude and phase of the oscillations at its user-defined attachment point. When all control signals are generated, the processing unit 510 is further configured to provide them to the actuators 506. The processing unit 510 may be implemented based on a general-purpose processor, single-purpose processor, microcontroller, microprocessor, GPU, application specific integrated circuit (ASIC), field programmable gate array (FPGA), digital signal processor (DSP), complex programmable logic device, etc. It should be also noted that the processing unit 510 may be implemented as any combination of one or more of the aforesaid. As an example, the processing unit 510 may be a combination of two or more microprocessors.

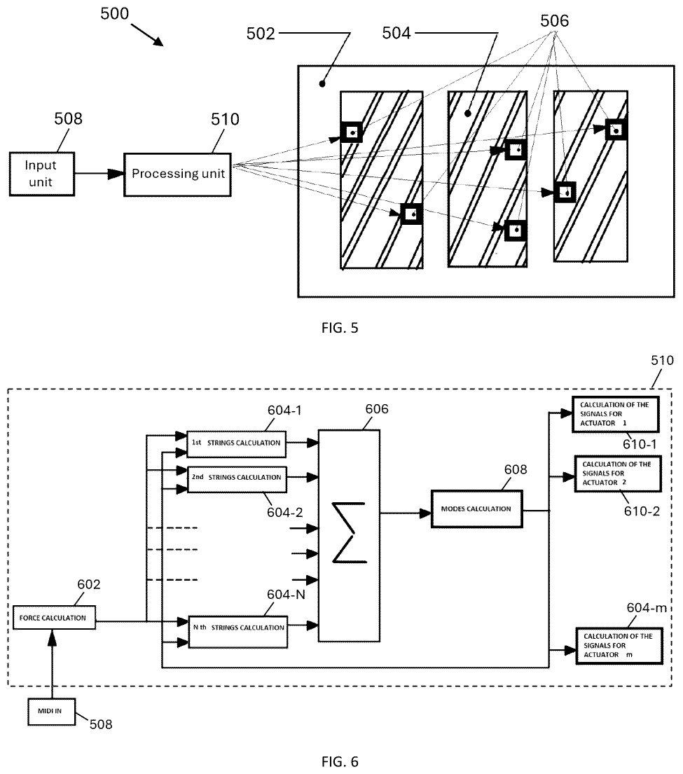

FIG. 6 shows a schematic block diagram of the processing unit 510 used in the instrument 100 according to one exemplary embodiment. In this embodiment, it is assumed that the input unit 508 is implemented as a MIDI keyboard configured to generate the input information as a MIDI sequence, the sounding board 502 is implemented as a piano soundboard, and the actuators are attached to the sounding board at the user-defined points, the exact locations of the attachment points are calculated using 3d modelling of the soundboard with the Finite Elements method. Given this, the processing unit 510 comprises a string excitation force generation sub-unit 602, string calculation sub-units 604-1-604-N (based on the number of the strings), a force summation sub-unit 606, a mode calculation sub-unit 608, and actuator signal generation sub-units 610-1-610-m (based on the number of the actuators 506).

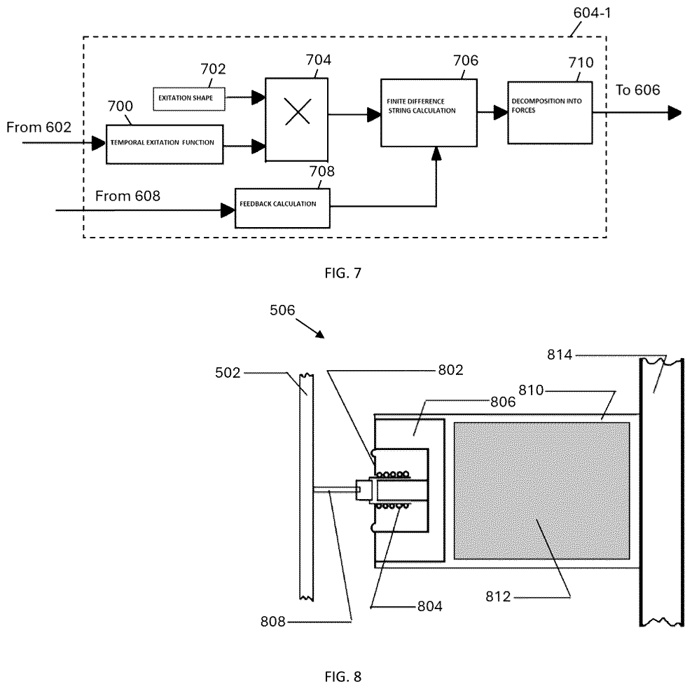

At the summation sub-unit 606, data arrays for all the (virtual) strings are received from the sub-units 604-1-604-N (the functions performed by the sub-units 604-1-604-N and the sub-unit 602 will be discussed in detail below with reference to FIG. 7). The output of the sub-unit 606 is an array having a length equal to the number of modes in the physical model of the piano. This data is then sent to the mode calculation sub-unit 608, the output of which is an array of mode amplitudes, also with a length equal to the number of modes in the physical model of the piano. In the actuator signal generation sub-units 610-1-610-m, the following mathematical operation is performed: Y=SUMM(A[i]*Coef [j][i]), where A[i] is the amplitude of the i-th mode, Coef [j][i] is the coefficient of the i-th mode for the j-th actuator 506, and Y is the amplitude of the output signal. The output of each of the sub-units 610-1-610-m is a control (audio) signal that is fed to the input of the corresponding actuator 506.

FIG. 7 shows some structural details of the processing unit 510 of FIG. 6. More specifically, FIG. 7 explains the functions of the sub-units 604-1-604-N and the sub-unit 602. As shown, in this embodiment, each of the sub-units 604-1-604-N may comprise a sequence providing component 700, a storage component 702, a multiplier 704, a finite difference scheme calculation component 706, a feedback calculation component 708, and a decomposition component 701.

The sequence providing component 700 is configured to store or generate a time-varying excitation force for a given string (which is subjected to physical modelling), while the storage component 702 is configured to store the shape of the time-varying excitation force along the string. The data from the components 700 and 702 are multiplied by the multiplier 704. The finite difference scheme calculation component 706 is configured to receive, as input, the time-varying excitation force and a new boundary condition for the point where the string is attached to the soundboard. The feedback calculation component 708 is configured to receive a vector of mode amplitudes from the sub-unit 608 and calculate the displacement of the points of the soundboards where the strings are attached in the real piano, thereby forming a feedback vector to be fed to the component 706.

More specifically, the component 706 performs iterative computation of the string segment coordinates at the next time step using an explicit finite difference scheme. The methods for doing that are well-known. An example of string calculation without considering bending stiffness can be represented by the following expression:

STR2[i]=(2*STR1[i]−STR0[i]+P*(STR1[i−1]+STR1[i+1]−2*STR1[i]+decr*STR0[i]+Fext*Shape[i])/(1+decr),
where STR2 [i]—traverse coordinate of the i-th segment of the string in the next moment in time, STR1[i]—traverse coordinate of the i-th segment of the string in the current moment in time, STR0 [i]—traverse coordinate of the i-th segment of the string in the previous moment in time, P-tension of the string, decr—damping coefficient of the string, Fext—external force, Shape[i]—external force profile along the string.

At each iteration, the component 706 calculates the force applied by the string on the soundboard at this string's fixation point. This value is fed once per iteration to the input of the component 710, where it is multiplied by the modal coefficients stored in it for the given string. The output of the component 710 is an array having a length equal to the number of modes in the physic model under consideration.

New border conditions for the string are being calculated in the component 708 which receives the signal from the sub-unit 608. The component 708 stores modal feedback coefficients for a given string STR.

FIG. 8 shows a schematic diagram of each electromagnetic actuator 506 that may be used in the instrument 500 according to one exemplary embodiment. As shown, the electromagnetic actuator 506 is attached to the sounding board 502 on one side and comprises a coil suspension 802, a coil 804, a magnetic core 806, a rod 808 (by which the actuator assembly is attached to the sounding board 502), an actuator housing 810, and a weight or load 812. 6.8—rigid support. The electromagnetic actuator 506 is attached to the fixed rigid support of the instrument 500. All the elements of the electromagnetic actuator 506 are assumed to have the capability for overall synchronization and individual loading of physical parameters.

The operational principle of the instrument 500 is as follows (given the implementation of the processing unit 510 which is shown in FIGS. 5-7).

All calculations are performed iteratively. The number of iterations per second depends on the number of the segments each sting is broken up into, sampling frequency and algorithm architecture.

The input unit 508 is assumed to a MIDI keyboard generating a MIDI sequence signal containing information about a note number and the velocity with which the key was pressed. The MIDI sequence signal is fed to the sub-unit 602 for calculating the string excitation force. The output of the sub-unit 602 is connected to the input of the component 700 which calculates the temporal excitation function for the corresponding string. This function depends on the type of the modeled musical instrument and can be either pulsed or continuous. It can be analytical or specified by a table. To model a piano hammer strike, one can use the following function:

F(t)=SUMM(Ai*exp(−Gi*(Di—t)*(Di—t)),

where the coefficients Ai, Gi Di are functions of the note velocity. Each iteration, the component 700 produces a vector of values of the forces applied to each string. This component also outputs a signal containing information about the state of the note—whether it is open or closed. Notes in the closed state have a higher damping coefficient. The position of the pedal determines a damping coefficient in the closed state for each note individually, within a range from the fully closed to the fully open state of the string.

The signals from the components 700 and 702 are fed via the multiplier 704 into the inputs of the component 706 which performs string calculations using the iteration method. In this process, the external force multiplied by the excitation shape is added to the difference scheme, thereby transferring energy to the string and causing it to vibrate. In the same component, the force with which the string acts on the point of its fixation to the soundboard is calculated. This force is multiplied in the component 710 by the modal coefficients of the given string, resulting in a vector of excitation forces acting on the corresponding modes for that string. In the sub-unit 606, these vectors from all strings are summed up, and the resulting vector of excitation forces is fed into the mode calculation sub-unit 608.

In the mode calculation sub-unit 608, new mode amplitudes are calculated, taking into account their previous states and the excitation force. Each i-th mode is represented as a resonator with a frequency W[i] and a quality factor Q[i]. The calculations may be performed using a waveguide model, a finite difference scheme, or an IIR filter. The output of the mode calculation sub-unit 608 is a vector of new mode amplitudes, which is sent to the inputs of the feedback calculation component 708 and to the inputs of the sub-units 610-1-610-m, where the amplitudes of the signals for the actuators 506 are calculated.

Thus, at each iteration, each of the sub-units 610-1-610-m in the processing unit 510 of the instrument 500 performs the following operations:
computes new traversal coordinates of the string segments for each string;
calculates the force with which each string acts on the soundboard at its attachment point and sequentially multiplies this force by the modal coefficients of the given string;
for each mode, calculates the resulting force applied to this mode by all strings by summing up the forces from each individual string with the corresponding coefficients;
calculates new amplitude for each mode;
for each string, calculates the resulting coordinate of the point where the string is attached to the soundboard (in relation to the string axis), and shifts the segment of the string located in that point in accordance with the calculated value.
for each actuator 506, sequentially multiplies the mode amplitudes by the modal coefficients of the given actuator and sums them up.

At the end of each iteration, new amplitude values for the actuators 506 are transmitted from the sub-units 610-1-610-m to the actuators 506. The actuators 506 apply corresponding excitation forces to the sounding board 502, causing it to move and emit soundwaves.

Thus, the acoustic field produced by the sounding board 502 may be identical to the acoustic field of the soundboard of the modelled musical instrument. By altering the quality factors of the modes and the modal coefficients, the acoustic parameters of the sounding board 502 may be significantly improved, and the timbre of the instrument 500 can be varied over a wide dynamic range. Additionally, a volume level may be adjusted without losing dynamic characteristics. The sound produced by the instrument 500 is as close as possible to that of a “live” musical instrument, providing a performer with the same nuanced control as on a real grand piano (continuous pedal operation, natural overtone excitation, the ability to achieve timbral and dynamic nuances).

Furthermore, the instrument 500 has an extended dynamic range as compared to the electronic instruments, and during setup, it is possible to eliminate the shortcomings of “live” musical instruments, such as the excitation of the piano soundboard at certain frequencies (the so-called “wolf tone”). The sound performance may also be tuned to the acoustics of the room, muting unwanted resonances. The instrument 500 may be used as a practice instrument in music educational institutions of all levels, in recording studios, as well as by amateur and professional musicians.

It should be also noted that the above-described physical modelling approach is applicable to any musical instrument comprising strings and a soundboard, such as guitar, violin, harp etc. Moreover, even non-keyboard musical instruments may be modeled with this approach, although their modeling will be less accurate.

Although the exemplary embodiments of the present disclosure are described herein, it should be noted that any various changes and modifications could be made in the embodiments of the present disclosure, without departing from the scope of legal protection which is defined by the appended claims. In the appended claims, the word “comprising” does not exclude other elements or operations, and the indefinite article “a” or “an” does not exclude a plurality. The mere fact that certain measures are recited in mutually different dependent claims does not indicate that a combination of these measures cannot be used to advantage.

1. An acoustic musical instrument comprising:
a rigid body;
a sounding board made of a flexible material and attached to the rigid body;
at least three actuators each attached to the sounding board at one of at least three user-defined attachment points, the at least three actuators being configured to cause the sounding board to perform oscillations that reproduce a musical sound of interest;
an input unit configured to receive an input information about the musical sound of interest; and
a processing unit configured to:
receive the input information from the input unit;
based on the input information, calculate an amplitude and phase of the oscillations to be performed by the sounding board at each of the at least three user-defined attachment points;
generate, for each of the at least three actuators, a control signal causing the actuator to exert an excitation force on the sounding board that corresponds to the calculated amplitude and phase of the oscillations at corresponding one of the at least three user-defined attachment points; and
provide the control signals to the at least three actuators.

2. The acoustic musical instrument of claim 1, wherein the sounding board is implemented as a soundboard of a stringed musical instrument, and wherein the at least three user-defined attachment points of the at least three actuators coincide with attachment points of strings to the sounding board of the stringed musical instrument.

3. The acoustic musical instrument of claim 2, wherein the input unit is implemented as a keyboard of the stringed musical instrument, and wherein the input information comprises a note identifier and a note velocity.

4. The acoustic musical instrument of claim 3, wherein the keyboard is a Musical Instrument Digital Interface (MIDI) keyboard, and wherein the input information is configured as a MIDI sequence.

5. The acoustic musical instrument of claim 2, wherein the processing unit is configured to calculate the amplitude and phase of the oscillations to be performed by the sounding board at each of the at least three user-defined attachment points by analyzing interaction between the strings and the soundboard of the stringed musical instrument using an explicit finite difference scheme.

6. The acoustic musical instrument of claim 1, wherein each of the at least three actuators is implemented as an electromagnetic or piezoelectric actuator.
